(19) United States
(12) Patent Application Publication
(10) Pub. No.: US 2009/0289603 A1
(43) Pub. Date: Nov. 26, 2009

(54) METHOD AND APPARATUS FOR MAINTAINING A BATTERY IN A PARTIALLY CHARGED STATE

(75) Inventor: Peter H. Mahowald, Los Altos, CA (US)

Correspondence Address: DORSEY & WHITNEY LLP;on behalf of APPLE, INC., 370 SEVENTEENTH ST., SUITE 4700, DENVER, CO, 80202-5647, US

(73) Assignee: Apple Inc., Cupertino, CA (US)

(21) Appl. No.: 12/124,588

(22) Filed: May 21, 2008

(51) Int. Cl. H02J 7/10

(52) U.S. Cl. 320/151; 320/161; 320/160

(57) ABSTRACT

A method and apparatus for controlling a battery charge. The embodiment may measure the charge level of a battery and determine if the charge level equals or exceeds a threshold. When the battery charge level does not equal or exceed the threshold, the battery may be charged.

### TECHNICAL FIELD

This invention relates generally to portable electronic devices with a rechargeable battery, and more specifically to methods and apparatus for maintaining a battery in a partially charged state.

### BACKGROUND

Rechargeable batteries may be found in a variety of portable electronic devices including laptop computers, personal digital assistants (PDAs), cell phones, digital media players, cameras, etc. The shelf life and cycle life of a rechargeable battery may be shortened when the battery is maintained in a fully charged state, such as when a laptop computer remains in a docking station on a user's desk for extended periods of time.

A shortened battery life may cause shorter duty cycles between charges, resulting in a reduced run time of the portable device when operated on battery power. It may also cause the battery to be discarded sooner, leading to environmental and recycling issues.

What is needed is a way to maintain a rechargeable battery in a partially charged state to prolong battery life. What is further needed is a way to override the partially charged battery state such that a fully charged battery is available when needed, e.g., when the laptop is removed from the docking station and taken to a meeting or on a business trip.

### SUMMARY

Various embodiments described herein are directed to maintaining a battery in a partially charged state. One embodiment may take the form of a method for controlling a battery charge. The method involves measuring a battery charge level, determining if the battery charge level of the battery equals or exceeds a threshold, and in the event the battery charge level does not equal or exceed the threshold, charging the battery.

Another embodiment may take the form of an apparatus for controlling a battery charge to extend battery life. The apparatus includes a charging circuit configured to provide a charge to a battery, a monitoring circuit configured to determine a battery charge level, and a control circuit coupled to the charging circuit and the monitoring circuit. The control circuit is configured to read the battery charge level, determine if the battery charge level is below a threshold, and, in the event the battery charge level is below the threshold, enable the charging circuit.

Yet another embodiment may take the form of a battery pack. The battery pack includes a rechargeable battery, a charging circuit configured to provide a charge to the rechargeable battery, a monitoring circuit configured to determine a battery charge level, and a control circuit coupled to the charging circuit and the monitoring circuit. The control circuit is configured to read the battery charge level, determine if the battery charge level is below a partial charge threshold, and, in the event the battery charge level is below the partial charge threshold, enable the charging circuit.

These and other embodiments and features will be apparent to those of ordinary skill in the art upon reading this disclosure in its entirety, along with the appended claims.

### BRIEF DESCRIPTION OF THE DRAWINGS

FIG. 1 is a block diagram of a rechargeable battery pack with a partial charge mode of operation.

FIG. 2 is a flowchart illustrating one method for maintaining a battery at a specified charge state.

FIG. 3 is a daily calendar with full charge check boxes to indicate a particular time when a fully charged battery should be provided.

FIG. 4 is a block diagram of a portable electronic device with electronic circuitry to maintain a rechargeable battery at a specified charge state.

FIG. 5 is a block diagram of an electronic circuit for maintaining a rechargeable battery at a specified charge state.

### DETAILED DESCRIPTION OF THE INVENTION

The shelf life and cycle life of a rechargeable battery may be prolonged when the battery is kept at an intermediate charge level other than full charge. For example, a lithium-ion battery may only last one to two years when maintained in a fully charged state. However, the lithium-ion battery may last four to five years when maintained in an intermediate charge state, for example 30, 50, or 70 percent of full charge, depending on the particular battery technology.

Other battery technologies, e.g., nickel-metal hydride, may prefer to be stored at a full charge, but may be damaged by an overcharge. Since it may be difficult to accurately determine the charge level of a battery, maintaining the charge level at a 95 percent of full charge level may extend the useful life of the battery by minimizing damage caused by overcharging.

One embodiment may cap a rechargeable battery charge state at an intermediate charge state to prolong battery life. This may allow the rechargeable battery to have a useful lifetime closer to the lifetime of the portable electronic device in which the battery is used. Further, by extending the useful battery life, fewer batteries (and their corresponding chemicals) end up in landfills.

A portable electronic device, such as a laptop computer, may include a lithium-ion battery pack to provide several hours of operation while the laptop computer is not connected to an external power source. However, the laptop may be run almost continuously on an external power source, such as when the laptop is attached to a docking station most of the time. In such circumstances, the battery may be maintained in a fully charged state if traditional charging circuits are employed.

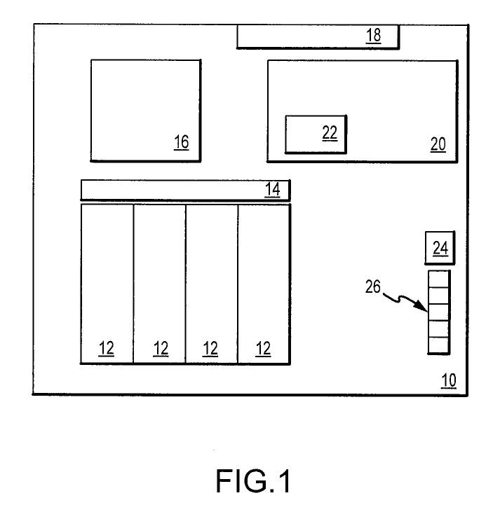

Referring to FIG. 1, a lithium-ion battery pack 10 may include one or more lithium-ion cells 12, one or more temperature sensors 14 to monitor the battery temperature, a voltage converter and regulator circuit 16 to maintain safe or manufacturer specified levels of voltage and current, a connector 18 that facilitates power and information transfer in and out of the battery pack, and a battery charge state monitor 20 which may include a microprocessor to handle the charging process in order to charge the battery as quickly as possible to the desired charge state. The information transferred may include charge/discharge cycles, charge left in the battery and battery temperature.

In one embodiment, the battery charge state monitor of the lithium-ion battery pack may use an electrically erasable programmable read-only memory (EEPROM) 22 to store one or more flags or status bits that specify how the battery pack is to be charged when connected to an external power source. As an example, one flag may, when set, indicate that the battery should be maintained in a partially charged state (i.e., a partial charge mode). That is, the battery may be charged up to a threshold. The threshold may indicate a partial charge relative to a full charge. In one non-limiting example, the threshold may be 50 percent of full charge. Once the battery pack has been charged to the threshold, the battery may be maintained at approximately the threshold by the embodiment.

Another flag, when set, may indicate that the battery is always charged to a full charge state. Alternatively, a single flag may be used to specify full charge mode versus partial charge mode. Additionally, another flag may be used to indicate that the partial charge mode, if enabled, is to be overridden. When this flag is enabled, the battery charge state monitor may provide a full charge to the battery pack on a one time (the flag is reset after the charge cycle) or recurring (flag is maintained until changed by the user) basis.

It is to be appreciated that the partial charge state at which a battery pack should be stored may depend upon the particular battery technology employed. For example, a lithium-ion battery may provide extended shelf life and cycle life when stored at approximately 70 percent of full charge. Other battery technologies may provide extended shelf life and cycle life when stored at other partial charge states. Thus, in one embodiment, the threshold may be programmable by a manufacturer and/or user of the battery or associated electronic device. For example, the threshold may be stored in the EEPROM 22. Alternatively, the threshold may be set via a voltage divider circuit such as a potentiometer. An analog to digital converter may be used to sense the analog voltage level and convert it to a digital value. In one embodiment, an eight bit converter may be used such that zero may represent a threshold value of zero percent of full charge and 255 may represent a threshold value of 100 percent of full charge.

The potentiometer may have a knob or slot to adjust the threshold. Thus either analog or digital approaches may be used to set the threshold in different embodiments.

In certain embodiments, the current charge state of the battery may be detected when external power is applied to the battery pack. This may be done to detect a battery usage pattern that would benefit by having the battery pack brought to a fully charged state. For example, the battery pack may be in a discharged state when it is connected to the external power source, indicating that the usage pattern may benefit by having the battery pack brought to a full charge state. The discharged state may be fully discharged, may be some percentage that represents the amount of charge available relative to a full charge, such as five percent charge (i.e., a discharge threshold) or may be time-based (e.g., 20 minutes of remaining battery life). The battery usage pattern may also be tracked over time to determine a charging profile. The charging profile may be used to determine when it would be beneficial to have the battery pack brought to a full charge state.

When a discharged battery pack condition is detected, the battery charge state monitor may override the partial charge mode and charge the battery to a full charge state.

One embodiment may include a battery charge status button 24 on the battery pack. When the user presses the battery charge usage button, the current charge state of the battery may be displayed. The charge state may be displayed on an LED bar meter 26 (or a LCD numerical display or other suitable display indicator). The user may override the partial charge state mode of operation by pressing and holding the battery charge status button down for a preset time. The button may blink (or provide other feedback, such as changing color) to indicate that the battery pack will be fully charged the next time the battery pack is connected to an external power source. In one embodiment, when the battery charge status button is held down for the preset time, the partial charge state override flag in the EEPROM may be enabled. It should be appreciated that the user may have to press and hold the button down each time a full charge state is desired when the partial charge mode of the battery pack is enabled. Alternatively, the user may hold down the battery charge status button for the preset time to toggle to the partial charge override mode and press and hold the button down for the preset time to toggle back to the partial charge mode. A status indicator may be provided for full versus partial charge mode.

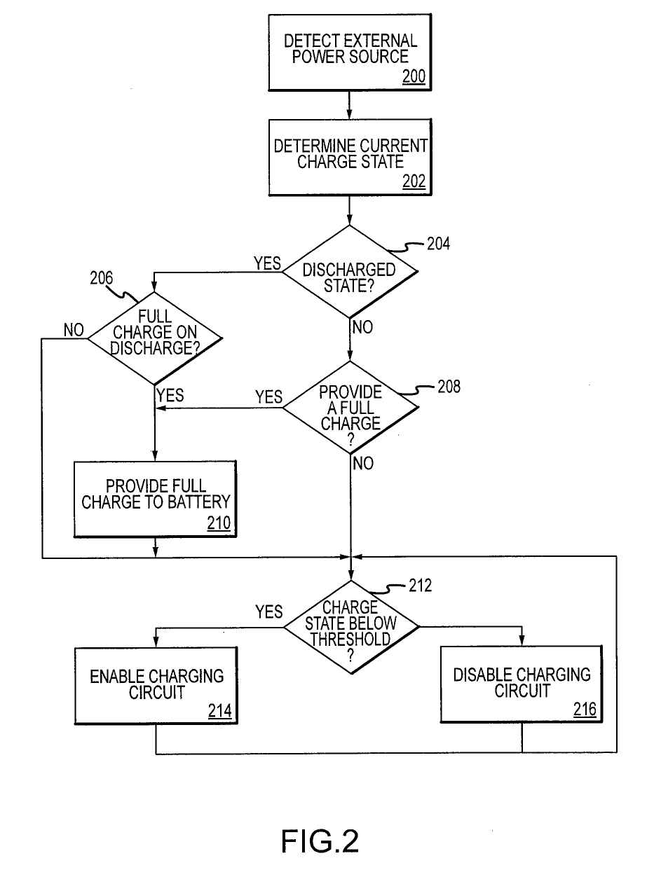

FIG. 2 is a flowchart illustrating one method for maintaining a battery pack at a specified charge state. Initially, in operation 200 the embodiment may detect that an external power source has been connected to the battery pack. Then, in operation 202 the embodiment may determine the current charge state of the battery pack.

Next, in operation 204 the embodiment may determine if the battery pack is in a discharged state. In some embodiments, the discharged state may be a fully discharged state. In other embodiments the discharged state may be a remaining charge expressed as a percentage of a fully charged state (e.g., five percent remaining charge) or may be a remaining battery life expressed in minutes. If, in operation 204 the embodiment determines that the battery pack is in a discharged state, operation 206 is performed.

In operation 206 the embodiment may determine if a full charge is to be provided when the battery pack is in a discharged state. If, in operation 206 the embodiment determines that a full charge is to be provided, operation 210 is performed. If, however, in operation 206 the embodiment determines that a full charge is not to be provided, operation 212 is performed.

In operation 210, the embodiment may charge the battery pack to a full charge state. Once the battery pack is fully charged, operation 212 is executed.

If, however, in operation 204 the embodiment determines that the battery pack is not in a discharged state, then operation 208 is performed. In operation 208 the embodiment may determine if the battery pack is to receive a full charge. If, in operation 208 the embodiment determines that the battery pack is to receive a full charge, then operation 210 is performed.

If, however, in operation 208 the embodiment determines that the battery pack is not to receive a full charge, then operation 212 is performed. In operation 212 the embodiment may determine if the charge state of the battery pack is below a threshold. If, in operation 212 the embodiment determines that the charge state of the battery pack is below the threshold, then operation 214 is performed.

In operation 214 the embodiment may enable a battery charging circuit to provide charge to the battery pack. Then, operation 212 is performed.

If, however, in operation 212 the embodiment determines that the charge state of the battery pack is at or above the threshold, then operation 216 is performed. In operation 216 the embodiment may disable the battery charging circuit. Thus, once the charge state of the battery pack reaches the threshold, no more charge will be provided until the charge of the battery pack drops below the threshold. This maintains the battery charge at the threshold. It is to be appreciated that some embodiments may employ a threshold with hysteresis such that the charge state of the battery pack is maintained within a specified charge range.

Alternatively, the battery charging circuit may be placed in a trickle charge mode to maintain the battery pack at approximately the threshold charge state. The trickle charge rate may be set to approximately the self discharge rate of the battery pack. Generally, the self discharge rate of a lithium-ion battery pack may be about 5% per month due to the power drawn by the battery charge state monitor and other electronic circuitry contained within the battery pack.

In one embodiment, the battery charge state monitor may use a temperature sensor within the battery pack to monitor the temperature of the battery pack. The battery charge state monitor may adjust the threshold based on the battery temperature to provide a partial charge state that compensates for the temperature of the battery pack.

The partial charge mode battery pack may be used in various portable electronic devices. For example, the battery pack may be used in a laptop computer, personal digital assistant, cell phone, digital music player, camera, etc. In one embodiment, the portable electronic device may include a function key that allows the partial charge state mode to be overridden. When the function key is pressed and the portable electronic device is operating on external power, the battery pack may be charged to a full charge state. Alternatively, if the portable electronic device is not currently operating on external power, the battery pack may be brought to a full charge state the next time the portable electronic device is connected to an external power source. In one embodiment, the function key may cause a software or firmware program to be executed that sets the partial charge state override flag in the EEPROM of the battery charge state monitor. It is to be appreciated that the function key on the portable electronic device may be replaced or augmented by a soft key that is displayed on the display screen of the portable electronic device. The user may utilize a mouse or other pointing device to click on the soft key to enable/disable (i.e., toggle) the override mode.

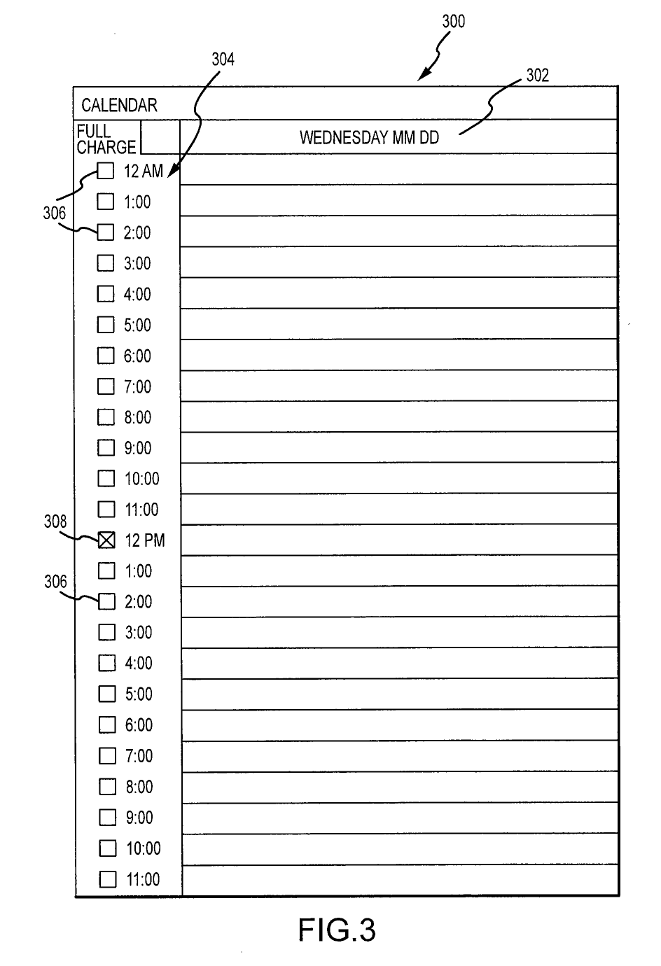

In one embodiment, the portable electronic device may include a calendar program (or some other predetermined user schedule) that may be used to override the partial charge mode of the battery pack. The calendar program may display a daily calendar 300, as depicted in FIG. 3, on the display screen of the portable electronic device. The daily calendar may include a day of the week with any of a month and day field 302, a set of hourly appointment times 304 and one or more check boxes 306 associated with the hourly appointment times. A checked check box 308 may indicate that a fully charged battery pack is needed by the corresponding calendar appointment time or that bringing the battery pack to a fully charged state is scheduled to begin at that time. A software program monitor may monitor the calendar appointments. When the software program monitor determines that a check box is checked, the software program monitor may determine a charge start time to begin charging the battery pack so that a fully charged battery pack may be available by the specified appointment time.

For example, a lithium-ion battery pack may require about three hours to become fully charged, depending on its current charge status. In this case, if a fully charged battery pack is required for a noon appointment, the override flag in the EEPROM may be enabled at 9 A.M. to provide the battery charge status monitor sufficient time to charge the battery pack. Alternatively, the start time may be based on the current charge state of the battery pack to minimize charge time. For example, a lithium-ion battery pack at 50 percent charge may only require one and one-half hours of charge time to reach full charge (i.e., the charger would be enabled at 10.30 AM). Yet another embodiment may charge the battery pack to a full charge state starting 24 hours prior to when the full charge is needed.

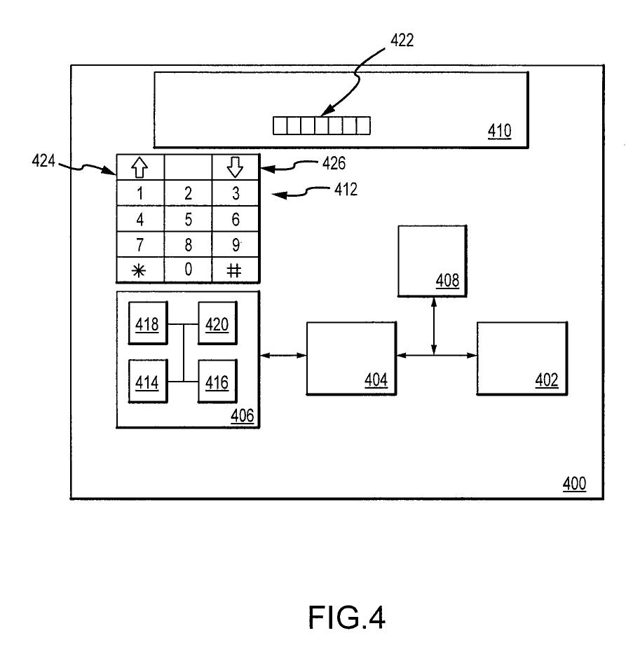

It should be noted that while the partial charge mode circuitry for maintaining the battery pack in a partial charge state may be included in the battery pack, alternative embodiments may incorporate the circuitry in the portable electronic device itself. This may be done when the battery pack does not include a battery charge status monitor and/or other charging circuitry. FIG. 4 depicts a block diagram of a portable electronic device 400 (e.g., a laptop computer) with a rechargeable battery 402. The portable electronic device may include a charging circuit 404, a control circuit 406, a monitoring circuit 408, a display 410 and an input device 412 (e.g., a key pad). The monitoring circuit may be used to provide a user with an indication of remaining charge in the battery when the portable electronic device is operating on battery power (i.e., as a battery meter). The control circuit may include a microprocessor 414, a ROM 416, an EEPROM 418 (or other erasable storage mechanism), and a programmable threshold 420.

In one embodiment, the programmable threshold may have a bar indicator 422 that is displayed on the display 410 of the portable electronic device. Up and down keys 424, 426, respectively, may be provided on the input device 412 to allow the user to set the threshold from zero percent of full charge to 100 percent of full charge in increments of 10 percent. Alternatively, up and down soft keys may be provided on the display. Other embodiments may provide larger or smaller threshold increments.

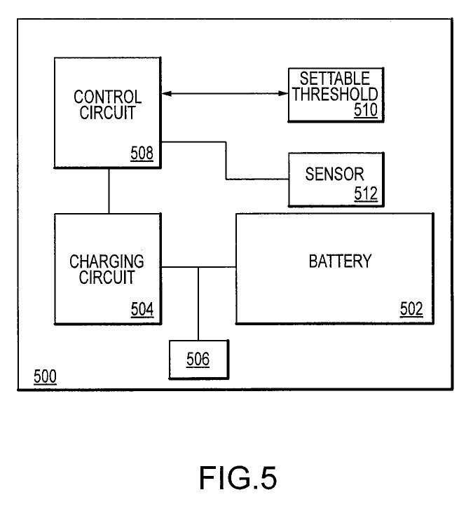

FIG. 5 depicts a block diagram of another embodiment taking the form of an electronic circuit 500 to maintain a rechargeable battery at a charge level other than 100 percent when the battery 502 is connected to the electronic circuit. The electronic circuit may be employed in a stand-alone battery charger. The electronic circuit may include a charging circuit 504, a monitoring circuit 506 and a control circuit 508. The charging circuit 504 may provide charge to the battery 502 as directed by the control circuit 508. The monitoring circuit 506 may measure the current charge state of the rechargeable battery connected to the electronic circuit. In one embodiment, the current charge state may be determined by monitoring the battery voltage or current flowing to the battery, or a combination of both. A lookup table may be employed to convert the battery voltage to a corresponding charge state.

The electronic circuit 500 may include a settable threshold 510 to indicate a charge level at which to maintain the battery 502, e.g., 70 percent of full charge. The control circuit 508 may read the current charge state of the battery via the monitoring circuit 506. When the current charge state is below the settable threshold 510, the control circuit may instruct the charging circuit to provide charge to the battery. When the battery charge state is at or above the settable threshold, the control circuit may instruct the charging circuit to stop providing charge to the battery. That is, the electronic circuit maintains the battery charge state at about the specified settable threshold while the battery is connected to the circuit. It is to be appreciated that certain embodiments may allow a plurality of batteries to be maintained at the specified settable threshold. Alternatively, each battery may have a separate settable threshold.

The settable threshold 510 may be set via a voltage divider circuit such as a potentiometer. An analog to digital converter may be used to sense an analog voltage level and convert it to a digital value. In one embodiment, an eight bit converter may be used such that zero may represent a threshold value of zero percent of full charge and 255 may represent a threshold value of 100 percent of full charge. The potentiometer may have a knob or slot to adjust the threshold. Thus either analog or digital approaches may be used to set the settable threshold in different embodiments.

The electronic circuit 500 may further include a temperature sensor 512 that is electrically coupled to the control circuit 508. The temperature sensor may measure the temperature of the battery 502. The control circuit may adjust the charge state of the battery based on the temperature reading provided by the temperature sensor. For example, a lithium-ion battery may retain 80% capacity after one year when stored at full charge at a temperature of 25 degrees Celsius, 65% capacity after one year when stored at full charge at a temperature of 40 degrees Celsius, 96% of capacity after one year when stored at 40% of full charge at 25 degrees Celsius and 85% of capacity after one year when stored at 40% of full charge at 40 degrees Celsius. The electronic circuit 500 may adjust the charge state of the battery based on the battery temperature to prolong battery life.

Although the present invention has been described with respect to particular embodiments and methods of operation, it should be understood that changes to the described embodiments and/or methods may be made yet still embraced by alternative embodiments of the invention. For example, certain embodiments may omit or add operations to the methods and processes disclosed herein. Accordingly, the proper scope of the present invention is defined by the claims herein.

What is claimed is:

1. A method for controlling a battery charge, comprising:
measuring a battery charge level;
determining if the battery charge level of the battery equals or exceeds a threshold; and
in the event the battery charge level does not equal or exceed the threshold, charging the battery.

2. The method of claim 1, wherein the threshold is seventy percent of the full charge condition of the battery.

3. The method of claim 1, further comprising:
monitoring a temperature of the battery; and
adjusting the threshold based at least in part on the temperature.

4. The method of claim 1, further comprising:
determining if the battery is discharged; and
in the event that the battery is discharged, fully charging the battery.

5. The method of claim 1, further comprising:
determining if a threshold override is enabled; and
in the event the threshold override is enabled, fully charging the battery.

6. The method of claim 5, further comprising:
checking a predetermined user schedule; and
determining if a threshold override is enabled on the predetermined user schedule.

7. The method of claim 6, wherein the operation of determining if the threshold override is enabled comprises:
determining if a specific time and date is set specifying when a fully charged battery is required; and
in the event a specific time and date is set, charging the battery to a full charge condition.

8. The method of claim 1, further comprising:
in the event the battery charge level equals or exceeds the threshold, trickle charging the battery.

9. A portable electronic device that implements the method of claim 1.

10. An apparatus for controlling a battery charge to extend battery life, comprising:
a charging circuit configured to provide a charge to a battery;
a monitoring circuit configured to determine a battery charge level; and
a control circuit coupled to the charging circuit and the monitoring circuit, the control circuit configured to read the battery charge level, determine if the battery charge level is below a threshold, and, in the event the battery charge level is below the threshold, enable the charging circuit.

11. The apparatus of claim 10, wherein the control circuit is further configured to place the charging circuit in a trickle charge mode in the event the battery charge level is not below the threshold.

12. The apparatus of claim 10, further comprising a temperature sensor coupled to the control circuit and configured to measure a temperature of the battery.

13. The apparatus of claim 12, wherein the threshold is based, at least in part, on the temperature.

14. The apparatus of claim 10, further comprising:
means for overriding the threshold; and
wherein the battery is charged to a fully charged state when the threshold is overridden.

15. The apparatus of claim 14, wherein the means for overriding the threshold comprises:
an interface including a display indicating the threshold; and
an input device for setting the threshold.

16. The apparatus of claim 14, wherein the means for overriding the threshold comprises a predetermined user schedule that includes a time and date specifying when the threshold is to be overridden.

17. A battery pack comprising:
a rechargeable battery;
a charging circuit configured to provide a charge to the rechargeable battery;
a monitoring circuit configured to determine a battery charge level; and
a control circuit coupled to the charging circuit and the monitoring circuit, the control circuit configured to read the battery charge level, determine if the battery charge level is below a partial charge threshold, and, in the event the battery charge level is below the partial charge threshold, enable the charging circuit.

18. The battery pack of claim 17, further comprising a settable partial charge threshold coupled to the control circuit.

19. The battery pack of claim 17, further comprising:
means for overriding the settable partial threshold; and
wherein the battery is charged to a fully charged state when the settable partial threshold is overridden.

20. The battery pack of claim 17, further comprising:
a temperature sensor coupled to the rechargeable battery and the control circuit, the temperature sensor configured to measure a temperature of the rechargeable battery; and
wherein the partial charge threshold is based, at least in part, on the temperature.
